(19) United States
(12) Patent Application Publication
(10) Pub. No.: US 2014/0149220 A1
(43) Pub. Date: May 29, 2014

(54) PLAY INFORMATION ESTABLISHING AND PLAYING SYSTEM, AND METHOD THEREOF

(71) Applicants: INVENTEC (PUDONG) TECHNOLOGY CORPOARTION, Shanghai (CN); INVENTEC CORPORATION, Taipei (CN)

(72) Inventor: Chaucer CHIU, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/795,467

(22) Filed: Mar. 12, 2013

(30) Foreign Application Priority Data
Nov. 23, 2012 (CN) 201210484111.5

(51) Int. Cl. G06Q 30/02

(52) U.S. Cl. CPC G06Q 30/0261
USPC 705/14.58

(57) ABSTRACT

A play information establishing and playing system, and a method thereof are provided. When an information establishing client sends coordinate information and play information to a server to establish a play information in the server, and a information query client sends queried coordinate information to the server, the corresponding play information is queried according to the queried coordinate information, and is provided to the information query client to play the play information, so as to achieve the technical efficacy of providing a corresponding play information according to different coordinate information.

### BACKGROUND OF THE INVENTION

1. Field of the Invention

The present invention relates to an information establishing and playing system, and a method thereof, and more particularly to an information establishing and playing system, and a method thereof by using coordinate information.

2. Description of Related Art

In the prior art, an advertisement or a government announcement is generally played through TV media, print media, or network media, so as to achieve a play effect for the advertisement or the government announcement.

For an advertiser and a government, generally, a play duration, the length of a material to be played, and so on of the advertisement or the government announcement may be selected, so as to determine a calculation standard for the pay according to different play durations and lengths of different materials, resulting in a high cost for playing the advertisement or the government announcement, or that in consideration of the cost, a short length or a poor play time is selected; however, a play effect for the advertisement or the government announcement is unobvious and even the play effect cannot be achieved.

In addition, a local condition cannot be taken into consideration for the advertisement or the government announcement, namely, the advertisement or the government announcement is played in an all-around manner through TV media, print media, or network media, and the advertisement or the government announcement cannot be played for a specific region, which also results in an undesirable play effect.

To sum up, it can be known that in the prior art, a problem that an advertisement or a government announcement cannot be played for different regions because of being played in an all-around manner has existed for a long time, so it is actually necessary to propose an improved technical means to solve this problem.

### SUMMARY OF THE INVENTION

In view of the problem in the prior art that an advertisement or a government announcement cannot be played for different regions because of being played in an all-around manner, the present invention discloses a play information establishing and playing system, and a method thereof.

A play information establishing and playing system disclosed in the present invention includes: a server, an information establishing client, and an information query client, where the server further includes: a server receiving module, a generation module, a storage module, a query module, a server transmission module, and a play database; the information establishing client further includes: a first receiving module and a first connection module; and the information query client further includes: a second receiving module, a second connection module, and a play module.

The server receiving module of the server is used for receiving coordinate information, play information, and queried coordinate information; the generation module of the server generates coordinate range information according to the coordinate information when the coordinate information is global positioning coordinate information; the storage module of the server correspondingly stores the coordinate information and the play information into the play database, or correspondingly stores the coordinate range information or the play information into the play database; the query module of the server is used for querying the play database for the play information corresponding to the queried coordinate information; and the server transmission module of the server is used for transmitting the play information.

The first receiving module of the information establishing client is used for receiving the coordinate information and the play information; and the first connection module of the information establishing client is used for connecting to the server and providing the coordinate information and the play information to the server receiving module.

The second receiving module of the information query client is used for receiving the queried coordinate information; the second connection module of the information query client is used for connecting to the server, providing the queried coordinate information to the server receiving module, and obtaining the play information from the server transmission module; and the play module of the information query client is used for playing the play information.

A play information establishing and playing method disclosed in the present invention includes the following steps.

First, an information establishing client receives coordinate information and play information; then, the information establishing client establishes a connection to a server, and provides the coordinate information and the play information to the server; then, when the coordinate information is global positioning coordinate information, the server generates coordinate range information according to the coordinate information; then, the server correspondingly stores the coordinate information and the play information into a play database, or correspondingly stores the coordinate range information and the play information into the play database; an information query client receives queried coordinate information; then, the information query client establishes a connection to the server, and provides the queried coordinate information to the server; then, the server queries the play database for the play information corresponding to the queried coordinate information; and finally, the server transmits the play information to the information query client, and the information query client plays the play information.

The system and the method disclosed in the present invention are described as above. The difference from the prior art lies in that, in the present invention, a user may send coordinate information and a play information to the server through the information establishing client, so as to correspondingly store the coordinate information and the play information, and when the user sends queried coordinate information to the server through the information query client, the corresponding play information can be queried according to the queried coordinate information, so as to provide the play information to the information query client to play the play information, thereby conveniently and rapidly establishing the play information for the user and playing a different play information in coordination with different coordinate information.

Through the foregoing technical means, the present invention can achieve the technical efficacy of providing corresponding play information according to different coordinate information.

### BRIEF DESCRIPTION OF THE DRAWINGS

The invention will become more fully understood from the detailed description given herein below illustration only, and thus is not limitative of the present invention, and wherein:

FIG. 1 is a block diagram of a play information establishing and playing system of the present invention.

FIG. 2 is a flowchart of a play information establishing and playing method of the present invention.

FIG. 3 shows a schematic architecture diagram of establishing and playing a play information of the present invention.

FIG. 4 is a schematic diagram showing content of a play database in play information establishing and playing of the present invention.

### DESCRIPTION OF THE EMBODIMENTS

Implementation manners of the present invention are illustrated in detail below with reference to accompanying drawings and embodiments, so that the implementation procedure about how the technical means is applied to the present invention to solve the technical problem and achieve the technical efficacy can be fully understood and implemented accordingly.

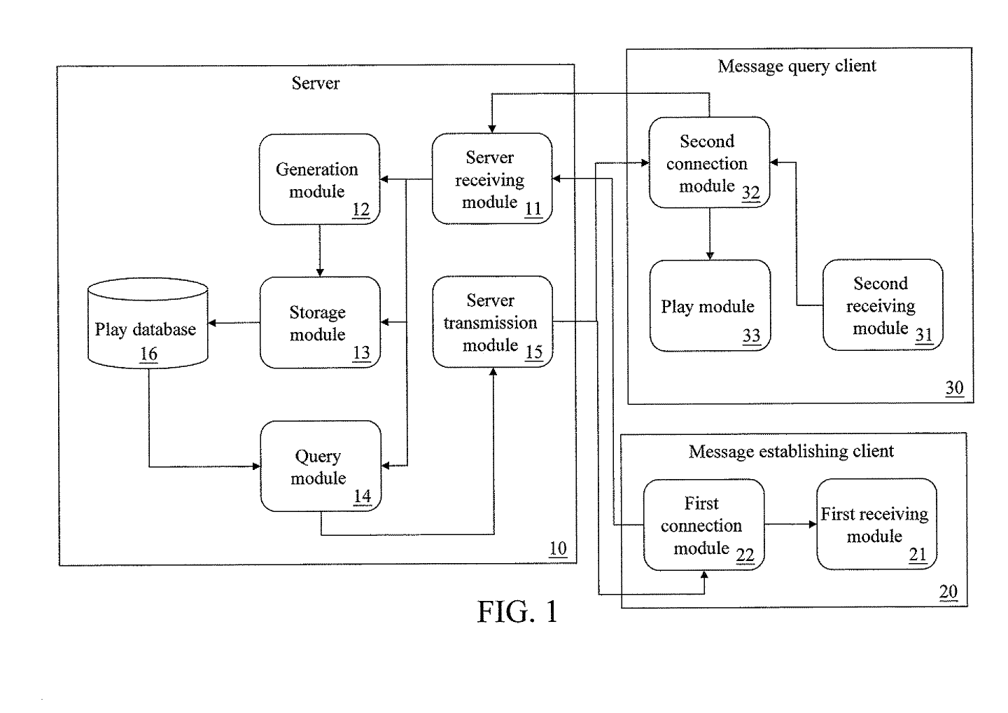

First, a play information establishing and playing system disclosed in the present invention is illustrated below with reference to FIG. 1, and FIG. 1 is a block diagram of a play information establishing and playing system of the present invention.

The play information establishing and playing system disclosed in the present invention includes: a server 10, an information establishing client 20, and an information query client 30, where the server 10 further includes; a server receiving module 11, a generation module 12, a storage module 13, a query module 14, a server transmission module 15, and a play database 16; the information establishing client 20 further includes: a first receiving module 21 and a first connection module 22; and the information query client 30 further includes: a second receiving module 31, a second connection module 32, and a play module 33.

The information establishing client 20 is a common electronic device, and the information establishing client 20 may be, for example, a desktop computer, a smart phone, a notebook computer, a tablet PC, or the like. A user uses the information establishing client 20 to establish or generate play information, where the play information may be a combination of a text, a picture, a video, an audio effect, and music, such as an advertisement or a government announcement, and obtains coordinate information through a Global Positioning System (GPS) or a Location Based Service (LBS) of the information establishing client 20, where the coordinate information is global positioning coordinate information at this time, or inputs coordinate information through a user interface provided by the information establishing client 20, where the coordinate information is power coordinate information at this time.

Power coordinate information is a geographic coordinate used in an electrical device, and generally the power coordinate information is established by adopting a TWD67 coordinate (namely, transverse Mercator projection two-degree zoning TM coordinate) and in a predefined coding manner, where the Mercator projection method, also called a Mercator projection method or a positive-axis conformal cylindrical projection, is one of conformal cylindrical map projection methods.

The process of converting the power coordinate information into a transverse Mercator projection two-degree zoning TM coordinate (TWD67, Taiwan Datum 1967) is described below through the power coordinate information “R1998 EE79”. First, Taiwan (including outlying islands) is divided into blocks A to Z by a range of the length of 80 kilometers from east to west and the width of 50 kilometers from south to north; each block takes a westernmost X coordinate and a southernmost Y coordinate as an original point of each block; and for the power coordinate information “R1998 EE79”, a location thereof is in an R block, where a westernmost X coordinate of the R block is 250000 meters, and a southernmost Y coordinate is 2500000 meters.

Then, in a range of each large block (80 kilometers×50 kilometers), the large block is divided into 10000 small regions having different figure numbers by a range of the length of 800 meters form east to west and the width of 500 meters from south to north; for the power coordinate information “R1998 EE79”, “R1998” represents the 1998th region in the R block and conversion of a coordinate of an original point of “R1998” is shown as follows:

X coordinate: 250000 (an original point of the R block)+19×800=265200 meters; and

Y coordinate: 2500000 (an original point of the R block)+98×500=2549000 meters;

then, the original point of 1998th region of the R block is as follows: X: 265200, and Y: 2549000.

Then, for each region with a figure number (800 meters×500 meters), the each region is divided into 40 small areas of 100 meters×100 meters from A to H east to west, and A to E south to north by a range of 100 meters×100 meters; for the power coordinate information “R1998 EE79”, “EE” represents an EE area in the 1998th region of the R block, and conversion of a coordinate of an original point of “R1998 EE” is shown as follows:

X coordinate: 265200 (an original point of the 1998th region)+4×100=265600 meters; and

Y coordinate: 2549000 (an original point of the 1998th region)+4×100=2549400 meters;

then, the original point of the EE area of the 1998th region of the R block is: X: 265600, and Y: 2549400.

Then, a range represented by the mantissa “79” of the power coordinate information “R1998 EE79” is a square region of 10 meters that is 7×10 meters east and 9×10 meters north from the original point of the EE area, namely, a coordinate of an original point of 79 of the EE area of the 1998th region of the R block is X: 265670, and Y: 2549490, namely, the power coordinate information “R1998 EE79” converted into the TWD67 coordinate is X: 265670, and Y: 2549490, where although the area represented by the converted coordinate is still an area of 10 meters×10 meters, it is a range where appearance of each other can be visually and clearly identified.

Through the foregoing description, the process of conversion between the power coordinate information and the TWD67 coordinate is clearly known and the power coordinate information is also understood. Then, the first receiving module 21 of the information establishing client 20 may receive the coordinate information and the play information, and the first connection module 22 of the information establishing client 20 may establish a connection to the server 10, so as to provide the coordinate information and the play information to the server receiving module 11 of the server 10 through the first connection module 22 of the information establishing client 20, where the first connection module 22 of the information establishing client 20 may establish a connection to the server 10 through a wired network, a WIFI wireless network, Bluetooth, or the like, which is just an example for illustration herein and are not intended to limit the application scope of the present invention.

After the server receiving module 11 of the server 10 receives the coordinate information and the play information that are provided by the first connection module 21 of a first client 20, when the coordinate information is global positioning coordinate information, the generation module 12 of the server 10 may generate coordinate range information according to the coordinate information, namely, select a vertex of any geometrical shape as the coordinate range information centring the global positioning coordinate information, where generally, a geometrical shape of a circle or a rectangle is frequently used; and when the coordinate information is power coordinate information, the generation module 12 of the server 10 does not need to generate the coordinate range information according to the coordinate information.

Specifically, it is assumed that the global positioning coordinate information obtained by the server receiving module 11 of the server 10 is “121°48′38″ E, 31°25′17″ N”, the coordinate range information generated, by the generation module 12 of the server 10, by selecting a rectangle centring the global positioning coordinate information “121°48′38″ E, 31°25′17″ N” is respectively “121°45′38″ E, 31°27′17″ N”, “121°51′38″ E, 31°27′17″ N”, “121°45′38″ E, 31°23′17″ N”, and “121°51′38″ E, 31°23′17″ N”.

Then, the storage module 13 of the server 10 may correspondingly store the coordinate information and the play information into the play database 16, or the storage module 13 of the server 10 correspondingly stores the coordinate range information and the play information into the play database 16, so as to rapidly and conveniently establish the play information in the server 10.

Then, the information query client 30 is also a common electric device, and the information query client 30 may be, for example, a desktop computer, a smart phone, a notebook computer, a tablet PC, or the like, and when the user uses the information query client 30 to obtain the play information, the user can obtain the queried coordinate information through a GPS or an LBS of the information query client 30, or inputs the queried coordinate information through a user interface provided by the information query client 30, where at this time, the queried coordinate information is power coordinate information.

Then, the second receiving module 31 of the information query client 30 may receive the queried coordinate information, and the second connection module 32 of the information query client 30 may establish a connection to the server 10, so as to provide the queried coordinate information to the server receiving module 11 of the server 10 through the second connection module 32 of the information query client 30, where the second connection module 32 of the information query client 30 may establish a connection to the server 10 through a wired network, a WIFI wireless network, Bluetooth, or the like, which is only an example for illustration herein and is not intended to limit the application scope of the present invention.

After the server receiving module 11 of the server 10 receives the queried coordinate information provided by the second connection module 32 of the information query client 30, the query module 14 of the server 10 may query the play database 16 for the play information corresponding to the queried coordinate information, namely, when the queried coordinate information is global positioning coordinate information, the coordinate range information where the queried coordinate information is located is first queried, and then the corresponding play information is queried, and when the queried coordinate information is power coordinate information, coordinate information same as the queried coordinate information is queried, and the corresponding play information is queried.

After the query module 14 of the server 10 queries the play information corresponding to the queried coordinate information, the server transmission module 15 of the server 10 may transmit the play information to the information query client 30, and the second connection module 32 of the information query client 30 may obtain the play information from the server transmission module 15 of the server 10.

After the second connection module 32 of the information query client 30 obtains the play information, the play module 33 of the information query client 30 may play the play information, specifically, the play module 33 of the information query client 30 may play the play information such as an advertisement, a government announcement, or the like formed by a combination of a text, a picture, a video, an audio effect, and music.

Therefore, the user may rapidly and conveniently obtain play content such as an advertisement, a government announcement, or the like according to the coordinate information.

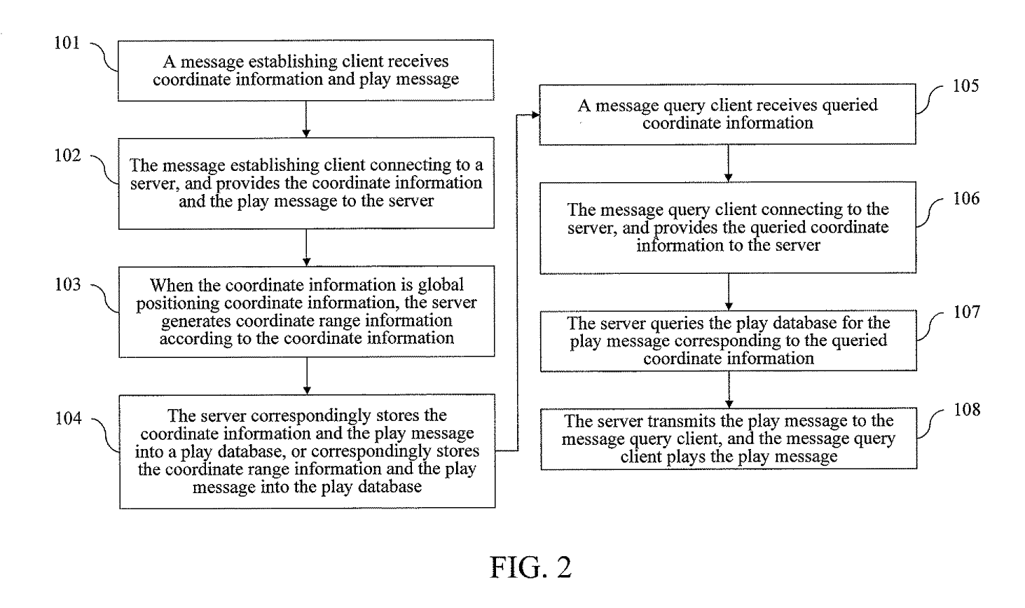

Then, an operating manner and flow of the present invention is illustrated below with reference to an embodiment, and illustration of the following embodiment is illustrated in coordination with FIG. 1 and FIG. 2, where FIG. 2 is a flowchart of a play information establishing and playing method of the present invention.

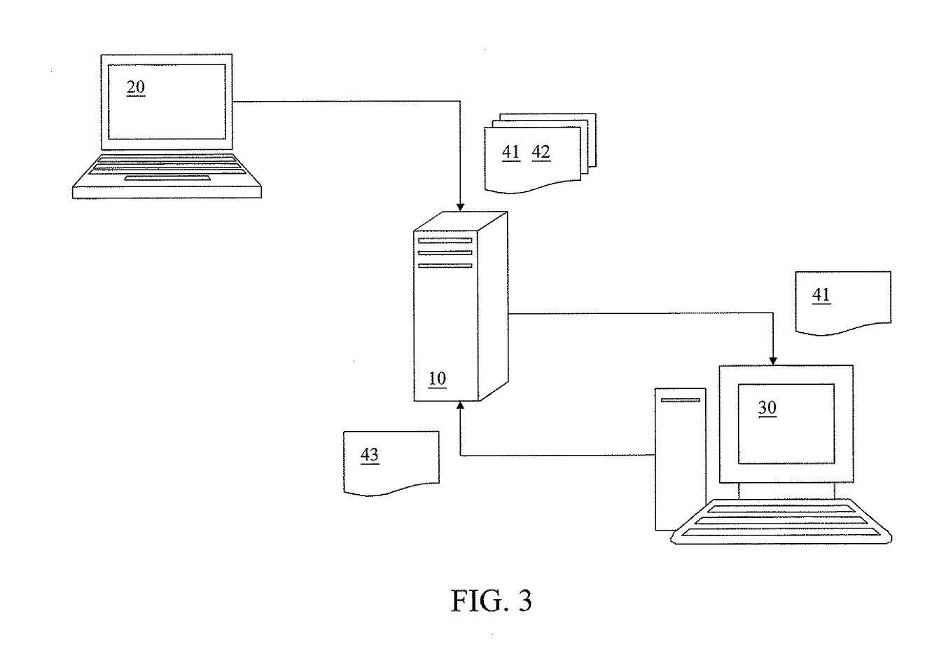

As shown in FIG. 3, FIG. 3 is a schematic architecture diagram of establishing and playing play information of the present invention.

An information establisher first establishes or generates play information 41 through an information establishing client 20, and obtains, through a GPS of the information establishing client 20, coordinate information 42 “121°48′38″ E, 31°25′17″ N” (namely, global positioning coordinate information); and a first receiving module 21 of the information establishing client 20 receives the play information 41 and the coordinate information 42 (Step 101).

After the first receiving module 21 of the information establishing client 20 receives the play information 41 and the coordinate information 42, a first connection module 22 of the information establishing client 20 may establish a connection to a server 10 through a WIFI wireless network, so as to provide the play information 41 and the coordinate information 42 to the server 10 through the first connection module 22 of the information establishing client 20 (Step 102), and a server receiving module 11 of the server 10 may receive the play information 41 and the coordinate information 42 provided by the first connection module 22 of the information establishing client 20.

Because the coordinate information 42 received by the server receiving module 11 of the server 10 is “121°48′38″ E, 31°25′17″ N” (namely, the global positioning coordinate information), coordinate range information generated by selecting a rectangle by a generation module 12 of the server 10 centring the coordinate information 42 “121°48′38″ E, 31°25′17″ N” is respectively “121°45′38″ E, 31°27′17″ N”, “121°51′38″ E, 31°27′17″ N”, “121°45′38″ E, 31°23′17″ N”, and “121°51′38″ E, 31°23′17″ N” (Step 103).

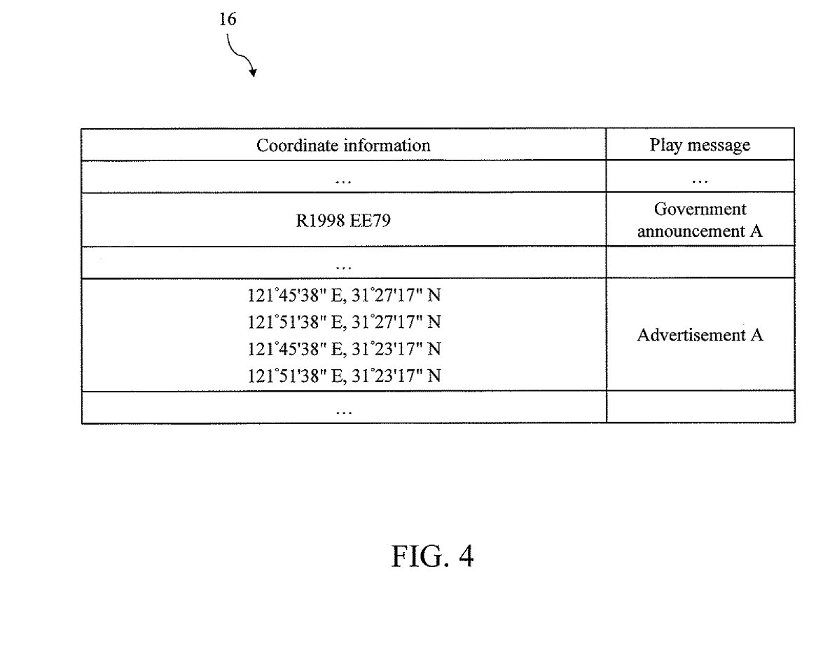

Then, a storage module 13 of the server 10 correspondingly stores the coordinate range information “121°45′38″ E, 31°27′17″ N”, “121°51′38″ E, 31°27′17″ N”, “121°45′38″ E, 31°23′17″ N”, and “121°51′38″ E, 31°23′17″ N” and the play information 41 into a play database 16 (Step 104). Reference may made to FIG. 4 for content of the play database 16, and FIG. 4 is a schematic diagram showing content of a play database in play information establishing and playing of the present invention, so as to rapidly and conveniently establish the play information in the server 10.

Then, as shown in FIG. 3 and FIG. 4, an information querier inputs queried coordinate information 43 “R1998 EE79” in a user interface of a information query client 30, and a second receiving module 31 of the information query client 30 receives the queried coordinate information 43 (Step 105), and a second connection module 32 of the information query client 30 establishes a connection to the server 10 through a wired network, so as to provide the queried coordinate information 43 to the server 10 through the second connection module 32 of the information query client 30 (Step 106), and the server receiving module 11 of the server 10 may receive the queried coordinate information 43 provided by the second connection module 32 of the information query client 30.

After the server receiving module 11 of the server 10 receives the queried coordinate information 43 provided by the second connection module 32 of the information query client 30, a query module 14 of the server 10 may query the play database 16 that the play information 41 corresponding to the queried coordinate information 43 “R1998 EE79” is a “government announcement A” (Step 107).

After the query module 14 of the server 10 queries that the play information 41 corresponding to the queried coordinate information 43 “R1998 EE79” is the “government announcement A”, a server transmission module 15 of the server 10 may transfer the play information 41 being the “government announcement A” to the information query client 30 (Step 108), and the second connection module 32 of the information query client 30 may obtain the play information 41 being the “government announcement A” from the server transmission module 15 of the server 10.

After the second connection module 32 of the information query client 30 obtains the play information 41 being the “government announcement A”, a play module 33 of the information query client 30 may play the play information 41 being the “government announcement A” (Step 108), and the play module 33 of the information query client 30 may play the play information being the “government announcement A” formed in a combination of a text, a picture, a video, an audio effect, and music.

Therefore, the user may rapidly and conveniently obtain play content such as an advertisement, a government announcement, or the like according to the coordinate information.

To sum up, it can be known that, the difference between the present invention and the prior art lies in that, in the present invention, a user may send coordinate information and a play information to the server through the information establishing client, so as to correspondingly store the coordinate information and the play information, and when the user sends queried coordinate information to the server through the information query client, the corresponding play information can be queried according to the queried coordinate information, so as to provide the play information to the information query client to play the play information, thereby conveniently and rapidly establishing the play information for the user and playing a different play information in coordination with different coordinate information.

The technical means may solve a problem in the prior art that an advertisement or a government announcement cannot be played for different regions because of being played in an all-around manner, so as to achieve the technical efficacy of providing a corresponding play information according to different coordinate information.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A play information establishing and playing system, comprising:
a server, wherein the server further comprises:
a server receiving module, used for receiving coordinate information, play information, and queried coordinate information;
a generation module, used for generating coordinate range information according to the coordinate information when the coordinate information is global positioning coordinate information;
a storage module, used for correspondingly storing the coordinate information and the play information into a play database, or corresponding storing the coordinate range information and the play information into the play database;
a query module, used for querying the play database for the play information corresponding to the queried coordinate information; and
a server transmission module, used for transmitting the play information;
an information establishing client, wherein the information establishing client further comprises:
a first receiving module, used for receiving the coordinate information and the play information; and
a first connection module, used for connecting to the server, and providing the coordinate information and the play information to the server receiving module; and
an information query client, wherein the information query client further comprises:
a second receiving module, used for receiving the queried coordinate information;
a second connection module, used for connecting to the server, providing the queried coordinate information to the server receiving module, and obtaining the play information from the server transmission module; and
a play module, used for playing the play information.

2. The play information establishing and playing system according to claim 1, wherein the coordinate information and the queried coordinate information comprise global positioning coordinate information and power coordinate information.

3. The play information establishing and playing system according to claim 1, wherein the generation module selects a vertex of any geometrical shape as the coordinate range information centring the coordinate information as global positioning coordinate information.

4. The play information establishing and playing system according to claim 1, wherein the play information comprises a combination of a text, a picture, a video, an audio effect, and music.

5. The play information establishing and playing system according to claim 1, wherein the first receiving module and the second receiving module connecting to the server in wired or in wireless.

6. A play information establishing and playing method, comprising the following steps:
an information establishing client receiving coordinate information and play information;
the information establishing client connecting to a server, and providing the coordinate information and the play information to the server;
when the coordinate information is global positioning coordinate information, the server generating coordinate range information according to the coordinate information;
the server correspondingly storing the coordinate information and the play information into a play database, or correspondingly storing the coordinate range information and the play information into the play database;
an information query client receiving queried coordinate information;
the information query client connecting to the server, and providing the queried coordinate information to the server;
the server querying the play database for the play information corresponding to the queried coordinate information; and
the server transmitting the play information to the information query client, and the information query client playing the play information.

7. The play information establishing and playing method according to claim 6, wherein in the step of the information establishing client receiving the coordinate information and the play information, the coordinate information comprises global positioning coordinate information and power coordinate information; and in the step of the information query client receiving the queried coordinate information, the queried coordinate information comprises global positioning coordinate information and power coordinate information.

8. The play information establishing and playing method according to claim 6, wherein the step of the server generating the coordinate range information according to the coordinate information when the coordinate information is global positioning coordinate information is selecting a vertex of any geometrical shape as the coordinate range information centring the coordinate information as the global positioning coordinate information.

9. The play information establishing and playing method according to claim 6, wherein in the step of the information establishing client receiving the coordinate information and the play information, the play information comprises a combination of a text, a picture, a video, an audio effect, and music.

10. The play information establishing and playing method according to claim 6, wherein the step of the information establishing client connecting to the server is in wired or in wireless, and the step of the information query client connecting to the server is connecting to the server in wired or in wireless.
